(19) United States
(12) Patent Application Publication
(10) Pub. No.: US 2016/0224921 A1
(43) Pub. Date: Aug. 4, 2016

(54) SYSTEMS AND METHODS TO IMPROVE DEALER SERVICE PERFORMANCE

(71) Applicant: GM Global Technology Operations LLC, Detroit, MI (US)

(72) Inventors: ROBERT R. INMAN, ROCHESTER HILLS, MI (US); MICHAEL S. HARBAUGH, CLARKSTON, MI (US); JONATHAN H. OWEN, BEVERLY HILLS, MI (US)

(73) Assignee: GM Global Technology Operations LLC

(21) Appl. No.: 14/612,711

(22) Filed: Feb. 3, 2015

(51) Int. Cl. G06Q 10/06

(52) U.S. Cl. CPC G06Q 10/06393; G06Q 10/067

(57) ABSTRACT

Systems and methods for measuring and benchmarking dealer service retention values, and generating improvement guidance. The method facilitates analyzing and improving dealer service retention. A method provides a more granular measure for actual service retention value focusing on key performance categories and provides a benchmarked service retention value that controls for environmental factors outside of the dealer's control. The method enhances efforts of dealers to improve their service retention through comparing the dealer's actual service retention value to the benchmarked service retention value, prioritizing the performance categories by an amount of room for improvement in service retention, quantifying impact of controllable factors on an optimized service retention value, and prioritizing controllable factors by amounts by which of the factors would most efficiently increase the optimized service retention value per dollar invested for each particular dealer.

### TECHNICAL FIELD

The present disclosure relates generally to dealer service performance.

### BACKGROUND

Dealer service retention is generally a metric that measures the performance of a service department of a vehicle dealer. Dealer service metrics and benchmarks are often biased and provide unfair measures that are not accepted by the dealer network. For example, some metrics can make good performers look bad and poor performers appear good. In addition, very little actionable information is provided to dealers who want to improve service performance.

### SUMMARY

The present technology relates to improving dealer service retention.

According to an exemplary embodiment, a method for measuring and benchmarking dealer service retention values, and generating improvement guidance is described. The method facilitates analyzing and improving dealer service retention. Improved dealer service retention increases revenue and profit from parts, and increases the profitability of the dealer network. Indirectly, increased dealer service retention improves new vehicle sales because there is a positive relationship between dealer service retention and repeat vehicle sales.

The method provides a more granular measure for actual service retention value focusing on key performance categories and provides a benchmarked service retention value that controls for environmental factors outside of the dealer's control. The method enhances efforts of dealers to improve their service retention through comparing the dealer's actual service retention value to the benchmarked service retention value, prioritizing the performance categories by an amount of room for improvement in service retention, quantifying impact of controllable factors on an optimized service retention value, and prioritizing controllable factors by amounts by which of the factors would most efficiently lift the optimized service retention value per dollar invested for each particular dealer.

Another benefit of more granular metrics is that they provide customer segmentation that enables more efficient targeted marketing.

Other aspects of the present invention will be in part apparent and in part pointed out hereinafter.

### DESCRIPTION OF THE DRAWINGS

FIG. 1 illustrates schematically a system including a computing architecture, according to an embodiment of the present disclosure.

FIG. 2 illustrates a method for measuring, benchmarking, and generating improvement guidance to improve dealer service retention, according to an embodiment of the present disclosure.

FIG. 3 illustrates schematically a first dealer in a first area and a second dealer in a second area.

FIG. 4 shows an object representing values of actual service retention of Table 4 and the values of benchmarked service retention of Table 5.

FIG. 5 shows an object representing controllable factors and associated values of optimized service retention improvement.

FIG. 6 shows an object representing controllable factors and associated values of optimized service retention improvement efficiency.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

As required, detailed embodiments of the present disclosure are disclosed herein. The disclosed embodiments are merely examples that may be embodied in various and alternative forms, and combinations thereof. As used herein, for example, “exemplary,” and similar terms, refer expansively to embodiments that serve as an illustration, specimen, model or pattern.

While the present technology is described primarily herein in connection with automobile dealers that service automobiles, the technology is not limited to automobile dealers. The concepts can be used in a wide variety of applications, such as in connection with aircraft, marine craft, and other.

The present disclosure describes systems and methods that include 1) an improved metric of actual service retention, 2) a benchmarked service retention, and 3) a more-actionable feedback metric to enable dealers to take more-effective improvement actions.

The feedback metric includes improvement opportunities targeted to individual dealers. The improvement opportunities include a list of quantified controllable factors that are quantified according to impact on dealer service retention and are ordered according to impact on dealer service retention. Changes to the controllable factors by the dealer will increase dealer service retention. Increased dealer service retention increases part sales that are required by the service and increases the strength of a relationship, thereby increasing sales loyalty.

As described herein, the term “service retention” refers to a measure, which can be, e.g., observed or estimated using a model, of how many of the vehicles within a category are serviced by a dealer. Exemplary categories are based on whether a vehicle, which can be represented by a vehicle identification number (VIN), is within a geographic area associated with a dealer and whether the dealer sold the vehicle. Other categories are additionally or alternatively based on VIN-dealer service relationship, customer's elected dealer preference, corporate assignment, or specialized service capabilities.

As described in further detail below, actual service retention is calculated based on measured data (e.g., data indicating a dealer service retention measure that is observed within a category), whereas benchmarked service retention and optimized service retention are calculated based on a model. For example, when a dealers services a VIN within a time frame, data is entered as part of a dated Repair Order that is generated and the serviced VIN is labeled as retained. A retention rate can then be determined as the fraction of eligible VINs that are retained. The data entered at dealerships can be gathered and consolidated into a database (e.g., database 70 described below).

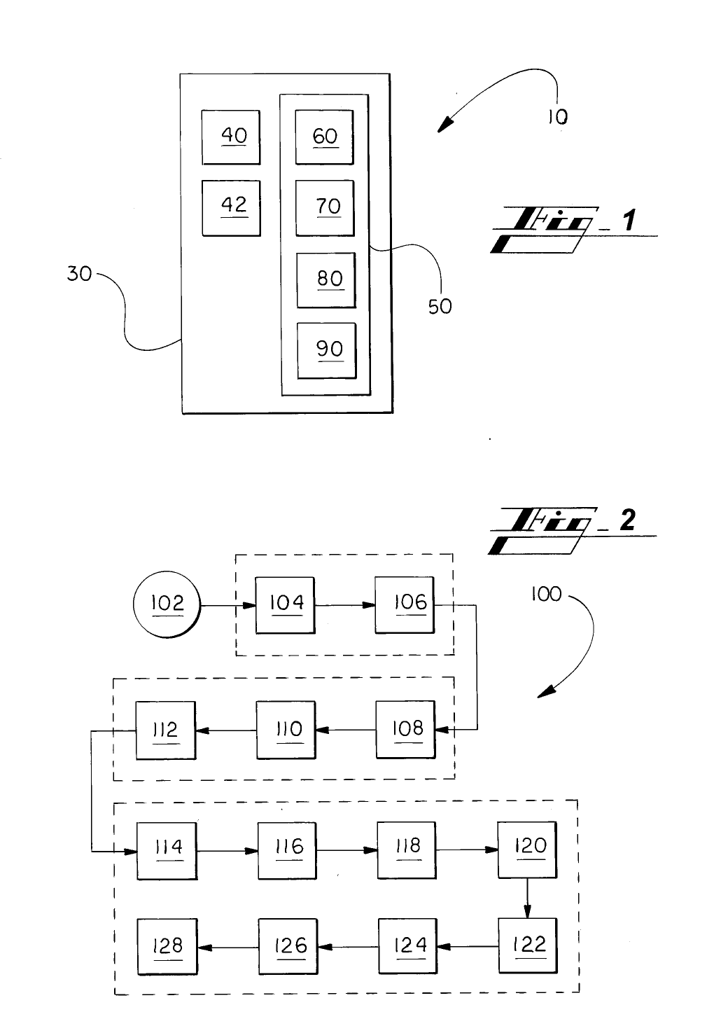

According to one embodiment, a system 10 is configured to perform a method 100 illustrated in FIG. 2. FIG. 1 illustrates schematically features of the system 10. The system 10 includes a computing unit 30. The computing unit 30 includes a processor 40 for controlling and/or processing data, input/output data ports 42, and a memory 50. Connecting infrastructure within the system 10, such as one or more data buses and wireless transceivers, are not shown in detail to simplify the figures.

The processor could be multiple processors, which could include distributed processors or parallel processors in a single machine or multiple machines. The processor could include virtual processor(s). The processor could include a state machine, application specific integrated circuit (ASIC), programmable gate array (PGA) including a Field PGA, or state machine. When a processor executes instructions to perform “operations,” this could include the processor performing the operations directly and/or facilitating, directing, or cooperating with another device or component to perform the operations.

The memory 50 can include a variety of computer-readable media, including volatile media, non-volatile media, removable media, and non-removable media. The term “computer-readable media” and variants thereof, as used in the specification and claims, includes storage media. Storage media includes volatile and/or non-volatile, removable and/or non-removable media, such as, for example, RAM, ROM, EEPROM, flash memory or other memory technology, CDROM, DVD, or other optical disk storage, magnetic tape, magnetic disk storage, or other magnetic storage devices or any other medium that is configured to be used to store information that can be accessed by the processor 40.

While the memory 50 is illustrated as residing proximate the processor 40, it should be understood that at least a portion of the memory can be a remotely accessed storage system, for example, a server on a communication network, a remote hard disk drive, a removable storage medium, combinations thereof, and the like. Thus, any of the data, applications, and/or software described below can be stored within the memory and/or accessed via network connections to other data processing systems (not shown) that may include a local area network (LAN), a metropolitan area network (MAN), or a wide area network (WAN), for example.

The memory 50 includes several types of software and data used in the computing unit 30 including applications 60, a database 70, an operating system 80, and input/output device drivers 90.

The operating system 80 may be any operating system for use with a data processing system. The input/output device drivers 90 may include various routines accessed through the operating system 80 by the applications to communicate with devices, and certain memory components. The applications 60 can be stored in the memory 50 and/or in a firmware (not shown) as executable instructions, and can be executed by the processor 40.

The applications 60 include various programs that, when executed by the processor 40, implement the various functions of the computing unit 30. The applications 60 are described in further detail below with respect to exemplary methods.

The term “application,” or variants thereof, is used expansively herein to include routines, program modules, programs, components, data structures, algorithms, and the like. Applications can be implemented on various system configurations, including single-processor or multiprocessor systems, minicomputers, mainframe computers, personal computers, hand-held computing devices, microprocessor-based, programmable consumer electronics, combinations thereof, and the like.

The applications 60 may use data stored in the database 70. The database 70 includes static and/or dynamic data used by the applications 60, the operating system 80, the input/output device drivers 90 and software programs that may reside in the memory 50.

It should be understood that FIG. 1 and the description above are intended to provide a brief, general description of a suitable environment in which the various aspects of some embodiments of the present disclosure can be implemented.

While the description refers to computer-readable instructions, embodiments of the present disclosure also can be implemented in combination with other program modules and/or as a combination of hardware and software in addition to, or instead of, computer readable instructions.

FIG. 2 shows an exemplary method 100 that facilitates analyzing and improving service retention, according to an embodiment of the present disclosure. It should be understood that the steps of the method 100 are not necessarily presented in any particular order and that performance of some or all the steps in an alternative order is possible and is contemplated. The steps have been presented in the demonstrated order for ease of description and illustration. Steps can be added, omitted and/or performed simultaneously without departing from the scope of the appended claims.

It should also be understood that the illustrated method 100 can be ended at any time. In certain embodiments, some or all steps of this process, and/or substantially equivalent steps are performed by execution of computer-readable instructions stored or included on a computer readable medium, such as the memory 50 of the computing unit 30 described above, for example.

The method 100 begins 102 and flow proceeds to blocks 104, 106, 108, 110, 112, 114, 116, 118, 120, 122, 124, 126, 128. Blocks 104, 106 are associated with computer executable instructions for a method of generating an improved metric of actual service retention; blocks 108, 110, 112 are associated with computer executable instructions for generating a benchmarked service retention; and blocks 114, 116, 118, 120, 122, 124, 126, 128 are associated with computer executable instructions for generating an optimized service retention and a more actionable feedback metric to enable dealers to take more effective improvement actions.

In block 104, the processor 40 accesses dealer service data stored in the memory 50. The dealer service data includes data that represents vehicles (e.g., same-brand vehicles), the dealer (or dealers) that have serviced each vehicle, and the location of the customer who owns (or leases) each vehicle. The dealer service data for a dealer is sorted or filtered into different categories or sets. A category can is represented by a cell of Table 1, as described in further detail below. In alternative embodiments, a category includes the more than one cell (e.g., a row or column). The variables in Table 1 represent a number of vehicles in different sets, as described in further detail below.

TABLE 1

| | Sold | Not Sold |
|---|---|---|
| In Area | v | x |
| | V | X |
| Out of Area | y | z |
| | Y | Z |

In Table 1, variable v is the number of vehicles that were sold by a first dealer to customers residing (e.g., currently residing, residence may be home or workplace) in the first dealer's area and that were serviced by the first dealer; variable x is the number of vehicles that were sold by another dealer (e.g., a second dealer) to customers residing in the first dealer's area and that were serviced by the first dealer; variable y is the number of vehicles that were sold by the first dealer to customers residing out of the first dealer's area (e.g., in a second dealer's area) and that were serviced by the first dealer; and variable z is the number of vehicles that were sold by another dealer (e.g., a second dealer) to customers residing out of the first dealer's area and that were serviced by the first dealer. In certain embodiments, a service by a dealer is counted in the number of vehicles serviced by the dealer only if the service is within a certain time window. For example, the time window is the first year of ownership, years 2-6 of ownership, or more than 6 years of ownership.

In Table 1, variable V is the number of vehicles that were sold by the first dealer to customers residing in the first dealer's area; variable X is the number of vehicles that were sold by another dealer (e.g., a second dealer) to customers residing in the first dealer's area; variable Y is the number of vehicles that were sold by the first dealer to customers residing out of the first dealer's area; and variable Z is the number of vehicles that were sold by another dealer (e.g., a second dealer) to customers residing out of the first dealer's area.

The cells of Table 1 represent two relationships between a dealer and a customer: a sales-based relationship and a geography-based relationship. By sorting the dealer service data into categories, a finer, more granular measure of actual service retention (ra) can be determined.

In block 106, the processor 40 calculates values of actual service retention raₖ using the sorted dealer service data. For example, values of actual service retention ra₁, ra₂, ra₃, ra₄ are calculated using values for the variables of Table 1 as follows:

$${ra}_{1} = \frac{v}{V}$$

$${ra}_{2} = \frac{x}{X}$$

$${ra}_{3} = \frac{y}{Y}$$

$${ra}_{4} = \frac{z}{Z}$$

An exemplary matrix representation of the dealer service data is as follows. Here, the dealer service data includes a service matrix (s), an area matrix (a), and a set of vehicles sold by a dealer (σ).

The rows i of the service matrix (s) represent VINs and the columns j of the service matrix (s) represent dealers. If a VIN i has been serviced by a dealer j, s(i,j)=1. Otherwise, s(i,j)=0.

The rows i of the area matrix (a) represent VINs and the columns j of the area matrix (a) represent dealers. If a VIN i is in an area of a dealer j, a(i,j)=1. Otherwise, a(i,j)=0.

The set of vehicles sold by a dealer (σ) is associated with a dealer j. An equation i∈σ(j) returns indices i that represent VINs sold by a dealer j. An equation i∉σ(j) returns the indices i that represent VINs that are not sold by a dealer j. The set of indices i returned by these equations are the indices i (e.g., VINs) of each of the service matrix (s) and the area matrix (a) to include in a count.

Each value of actual service retention raₖ is then calculated based on the service matrix (s), the area matrix (a), and the set of vehicles sold by a dealer (σ). Exemplary equations for calculating values of actual service retention raₖ and the relationship to the equations above are given by:

$${ra}_{1} ( j ) = \frac{{\sum }_{i ∈ σ ( j )} s ( i , j ) a ( i , j )}{{\sum }_{i ∈ σ ( j )} a ( i , j )} = \frac{v}{V}$$

$${ra}_{2} ( j ) = \frac{{\sum }_{i ∉ σ ( j )} s ( i , j ) a ( i , j )}{{\sum }_{i ∉ σ ( j )} a ( i , j )} = \frac{x}{X}$$

$${ra}_{3} ( j ) = \frac{{\sum }_{i ∈ σ ( j )} s ( i , j ) [ 1 - a ( i , j ) ]}{{\sum }_{i ∈ σ ( j )} [ 1 - a ( i , j ) ]} = \frac{y}{Y}$$

$${ra}_{4} ( j ) = \frac{{\sum }_{i ∉ σ ( j )} s ( i , j ) [ 1 - a ( i , j ) ]}{{\sum }_{i ∉ σ ( j )} [ 1 - a ( i , j ) ]} = \frac{z}{Z}$$

Generally, each value of actual service retention raₖ is a percentage of same-brand vehicles in operation that are serviced by a dealer for some combination of sales, geographical relationship, and/or time relationship. Additional equations for actual service retention ra are described in further detail below. An example using exemplary values for the variables of Table 1 is now described.

The technology applies to individual dealers as well as aggregations of dealers. For example, dealers can be aggregated by brand, country, or corporation.

This technology can be adapted to situations (i.e., countries or brands) without geographic areas or sales relationships (e.g., discontinued brands or private-sale used vehicles). If there is no applicable geographic subdivision, sales-based metrics can be used. If the sales relationship is not applicable, geographic-based metrics can be used.

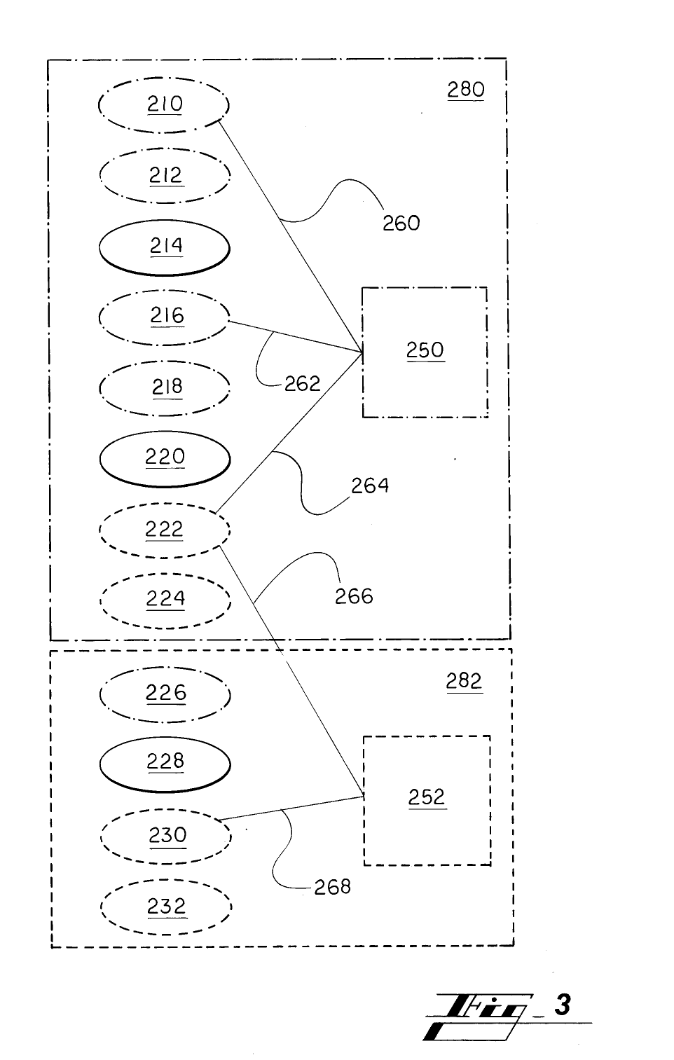

FIG. 3 schematically illustrates vehicles 210, 212, 214, 216, 218, 220, 222, 224, 226, 228, 230, 232, certain of which are serviced by a first dealer 250 and/or a second dealer 252. Service is represented by a line between a dealer and a vehicle. In FIG. 3, a service 260 is performed by dealer 250 on vehicle 210; a service 262 is performed by dealer 250 on vehicle 216; a service 264 is performed by dealer 250 on vehicle 222; a service 266 is performed by dealer 252 on vehicle 222; a service 268 is performed by dealer 252 on vehicle 232.

A vehicle that is sold by a dealer is represented by the same line pattern as the dealer. Dealer 250 sold vehicles 210, 212, 216, 218, 226 and dealer 252 sold vehicles 222, 224, 230, 232. Vehicles 214, 220, 228 were not sold by either of dealers 250, 252.

For purposes of teaching, the term “area” includes a geographical area, which can be defined by one or more of driving distance, drive time, a market, reach through a communication channel, and the like. The area may be referred to as an area of general sales and service advantage (AGSSA).

A first area 280 includes the first dealer 250 and vehicles 210, 212, 214, 216, 218, 222, 224 and a second area 282 includes the second dealer 252 and vehicles 226, 228, 230, 232. In the example of FIG. 3, for clarity, only two areas are illustrated and so “out of area” for one dealer is the area of the other dealer. However, where more than two dealers border or are otherwise near one another, “out of area” for one dealer includes more than the area of one other dealer.

Using FIG. 3, referring to Table 2, the values for the variables of Table 1 are determined for the first dealer 250.

TABLE 2
Table 1 with Values for first dealer 250

| | Sold | Not Sold |
|---|---|---|
| In Area | v = 2 | x = 1 |
| | V = 4 | X = 4 |
| Out of Area | y = 0 | z = 0 |
| | Y = 1 | Z = 3 |

Using equations above and the values of Table 2, values of actual service retention ra₁, ra₂, ra₃, ra₄ for dealer 250 (e.g., j=1) are ra₁=0.5, ra₂=0, ra₃=0.25, ra₄=0.

Using FIG. 3, referring to Table 3, the values for the variables of Table 1 are determined for the second dealer 252.

TABLE 3
Table 1 with Values for second dealer 252

| | Sold | Not Sold |
|---|---|---|
| In Area | v = 1 | x = 0 |
| | V = 2 | X = 2 |
| Out of Area | y = 1 | z = 0 |
| | Y = 2 | Z = 6 |

Using equations above and the values of Table 3, values of actual service retention ra₁, ra₂, ra₃, ra₄ for dealer 252 (e.g., j=2) are ra₁=0.5, ra₂=0.5, ra₃=0, ra₄=0.

Additional equations for calculating actual service retention ra are now described in further detail. For example, an exemplary equation for calculating actual service retention ra, focusing on the sales relationship, is given as:

$${ra}_{5} = \frac{v + y}{V + Y}$$

As another example, an exemplary equation for calculating actual service retention ra, focusing on the geographical relationship, is given as:

$${ra}_{6} = \frac{v + x}{V + X}$$

Further, exemplary equations for calculating actual service retention ra, combining the sales relationship and the geographical relationship, are given as:

$${ra}_{7} = \frac{v + x + y + z}{V + X + Y + z}$$

$${ra}_{8} = \frac{( \frac{v + y + z}{V + Y + z} + \frac{v + x + z}{V + X + z} )}{2}$$

In addition, a sales-based metric is calculated as the number of vehicles serviced by a first dealer (both sold and not sold by the first dealer) divided by the sum of the number of vehicles that were sold by the first dealer but that were serviced by another dealer or not serviced. This metric compares the number of vehicles that the first dealer serviced to the number of vehicles that the first dealer sold but didn't service.

In block 108, for each selected actual service retention raₖ and category k, the processor 40 generates a benchmark model fₖ that is used to calculate a value of benchmarked service retention rbₖ. The comparison model fₖ is based on dealer service data. The dealer service data includes values associated with uncontrollable factors u and values of actual service retention raₖ, which are calculated in the blocks described above (e.g., ra₁, ra₂, ra₃, ra₄).

Uncontrollable factors (u) are factors outside a dealer's control. For example, uncontrollable factors include customer demographics, brand, distance, geographic data, household data, competitor data, and the like (E.g., dealer network, customer demographics, competition, etc.). A general comparison model (fₖ) is represented as:

fₖ(U(d))=fₖ(u₁ₖ(d),u₂ₖ(d), . . . ,u_{N}_{^{u}}ₖ(d))

where uᵢₖ(d) denotes uncontrollable factor i for dealer d, and N^{u} denotes the number of uncontrollable factors in the statistical model.

The comparison model fₖ is a statistical association between values of uncontrollable factors u and values of actual service retention ra. The step of generating the comparison model fₖ includes factor analysis to find top uncontrollable factors u and reduce collinearity between the uncontrollable factors u, testing transformations of promising drivers for non-linear relationships, selecting potent non-collinear uncontrollable factors u, and creating a statistical model based selected uncontrollable factors u.

For example, the comparison model fₖ is a mathematical (e.g., logistic regression) model that is fit to values of the uncontrollable factors u and the values of actual service retention raₖ of a plurality of dealers d (e.g., all dealers). An exemplary benchmark model is given as:

rbₖ(d)=w₁u₁ₖ(d)+w₂u₂ₖ(d)+ . . . +w_{Nu}u_{Nuk}(d)

where rbₖ(d) is benchmarked service retention for a dealer d, uᵢₖ are uncontrollable factors for a category k, and wᵢ are weights that fit the uncontrollable factors u in a category k to values of actual service retention ra in a category k. For example, the weights w best fit all the uncontrollable factors u for all the dealers in a category k to all the values of actual service retention ra for all the dealers d in a category k.

In block 110, for each dealer d and selected category k, the processor calculates a value of benchmarked service retention rbₖ(d). Values for uncontrollable factors uᵢₖ for a dealer d and a category k are input to the mathematical model to calculate the value of benchmarked service retention rbₖ(d).

Referring to Table 4, for a single dealer, exemplary values of actual service retention ra₁, ra₂, ra₃, ra₄ are given as:

TABLE 4

| | Sold | Not Sold |
|---|---|---|
| In Area | ra₁ = 58% | ra₃ = 17% |
| Out of Area | ra₂ = 34% | ra₄ = 11% |

Referring to Table 5, for a single dealer d, exemplary values of benchmarked service retention rb₁, rb₂, rb₃, rb₄, which correspond to the measures of actual service retention ra₁, ra₂, ra₃, ra₄, are given as:

TABLE 5

| | Sold | Not Sold |
|---|---|---|
| In Area | rb₁ = 50% | rb₃ = 15% |
| Out of Area | rb₂ = 40% | rb₄ = 5% |

In block 112, for each dealer d, the processor 40 generates an object 400 that is configured to compare the value of actual service retention ra is to the corresponding value of benchmarked service retention rb. Referring to FIG. 4, the object 400 is a bar graph where the values of actual service retention ra₁, ra₂, ra₃, ra₄ of Table 4 are graphically represented as bars and respective values benchmarked service retention rb₁, rb₂, rb₃, rb₄ of Table 5 are represented as lines.

For example, the object 400 allows a dealer to identify underperformance in one or more measures of actual dealer retention ra. Underperformance is identified where a value of actual service retention ra is less than a respective value of benchmarked service retention rb.

In example of FIG. 4, the dealer is underperforming in the measure of actual dealer retention ra₂, which measures service for vehicles that are sold by the dealer and are out of the area of the dealer.

Table 4 and Table 5, together, are also an object that facilitates comparing a dealer's actual service retention ra to a benchmarked service retention.

In block 114, the processor 40 ranks or orders the actual service retention ra according to where greatest improvement is needed. The processor 40 calculates the difference between values of actual service retention ra and respective values of benchmarked service retention rb and ranks or orders the measures of actual service retention ra according to the differences. For example, the measures of actual service retention ra are ranked according to greatest dealer under-performance, which identifies the categories of greatest opportunity for the dealer.

In block 116, for each selected category k (e.g., categories where improvement is needed are selected), the processor 40 generates an improvement model gₖ based on the dealer service data. For example, the processor 40 generates an improvement model gₖ for one or more measures of actual service retention ra, which represent the greatest opportunity identified in the block 114. The dealer service data includes values associated with uncontrollable factors (u), values associated with controllable factors c, and values of actual service retention raₖ, which are calculated in the blocks described above (e.g., ra₁, ra₂, ra₃, ra₄).

Uncontrollable factors u are described above with respect to the comparison model fₖ. Controllable factors c are factors that are within the control of a dealer. Exemplary controllable factors c include service hours, capacity, pricing, customer satisfaction (e.g., as measured by a consumer satisfaction index (CSI)), advertising, and the like. A general comparison model (gₖ) for a category k is represented as:

gₖ(C(d),U(d))=gₖ(c₁ₖ(d),c₂ₖ(d), . . . ,c_{N}_{^{c}}ₖ(d),u₁ₖ(d),u₂ₖ(d), . . . ,u_{N}_{^{a}}ₖ(d))

where cᵢₖ(d) denotes controllable factor i for category k for dealer d, N^{c} denotes the number of controllable factors in the statistical model, uᵢₖ(d) denotes uncontrollable factor i for category k for dealer d, and N^{u} denotes the number of uncontrollable factors in the statistical model.

The improvement model gₖ is a statistical association between values of uncontrollable factors u, values of controllable factors c, and values of actual service retention ra. The step of generating the improvement model gₖ includes factor analysis to find top uncontrollable and controllable factors and reduce collinearity, testing transformations of promising drivers for non-linear relationships, selecting potent non-collinear controllable factors and uncontrollable factors, and creating a statistical model of selected controllable factors and uncontrollable factors. For example, the uncontrollable factors from the comparison model fₖ are selected for the improvement model gₖ.

For example, for each category k, the improvement model gₖ is a mathematical (e.g., logistic regression) model that is fit to values of the uncontrollable factors u, values of the controllable factors c, and values of actual service retention ra of a plurality of dealers (e.g., all dealers). An exemplary improvement model is given as:

roₖ(d)=w₁u₁ₖ(d)+w₂u₂ₖ(d)+ . . . +w_{Nu}u_{Nuk}(d)+w_{Nu+1}c₁ₖ(d)+w_{Nu+2}c₂ₖ(d)+ . . . +w_{Nu+Nc}c_{Nck}(d)

where roₖ(d) is optimized service retention for a dealer d (e.g., a target retention or expected retention), uᵢₖ are uncontrollable factors, cᵢₖ are controllable factors, and wᵢ are weights that best fit the values of the uncontrollable factors u and the values of the controllable factors c to values of actual service retention ra.

In block 118, the processor 40 performs a sensitivity analysis on the controllable factors c of the improvement model gₖ to prioritize improvement opportunities for each dealer d. Using the improvement model, the sensitivity analysis includes setting the uncontrollable factors u to be equal to the observed values of the uncontrollable factors of the dealer, and perturbing the controllable factors c to quantify the impact on the optimized service retention ro. In other words, the controllable factors c are changed to determine which are most effective in improving optimized service retention ro.

Each of the controllable factors c are changed within a range of possible values for the controllable factor c. For example, for each controllable factor c, the lower limit of the range is the lowest observed value for the controllable factor c of all the dealers and the upper limit of the range is a greatest observed value for the controllable factor c of all the dealers. As another more specific example, a range of possible values of pricing can be determined according to a model for determining price elasticities based on pricing data of a dealer and local competitors.

To perturb the controllable factors c, the controllable factors c are changed one at a time or by another method. The optimized service retention improvement Δro is recorded for each value of a control factor c within the range. For example, the optimized service retention improvement Δro is recorded as a percentage increase in optimized service retention ro.

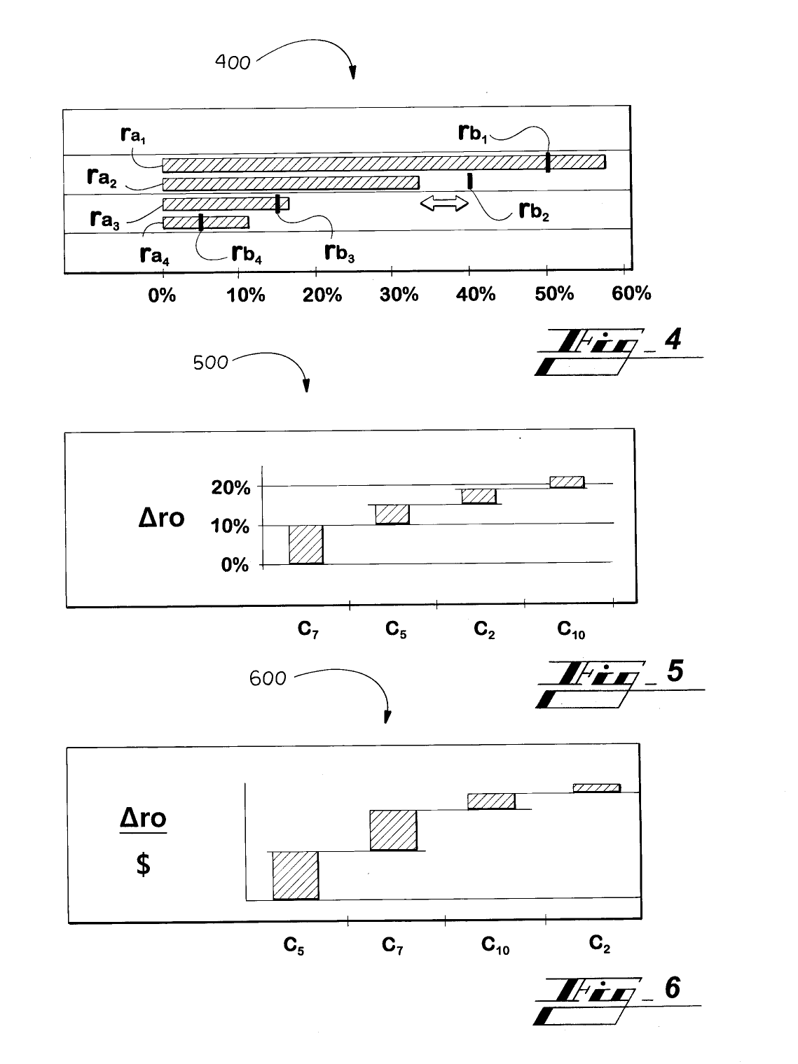

In block 120, the processor 40 creates an object 500 that displays the optimized service retention improvement Δro for each of the controllable factors c. For example, referring to FIG. 5, the controllable factors c are shown in a Pareto chart. Exemplary controllable factors c₇, c₅, c₂, c₁₀ are ordered from highest optimized service retention improvement Δro to lowest optimized service retention improvement Δro. As such, the Pareto chart identifies the controllable factors c of greatest opportunity in a category k.

Specifically, a first controllable factor c₇ gives a highest optimized service retention improvement Δro. If the first controllable factor c₇ is addressed, a second controllable factor c₅ gives an additional (next highest) optimized service retention improvement Δro, and so on.

The object 500 is reported to the dealer and facilitates improvement in actual service retention ra since it communicates how much improvement can be made by changing controllable factors and which controllable factors are a priority.

A process for further prioritizing the controllable factors of the object 500 of FIG. 5 is now described. At block 122, the processor displays the object 500 to the dealer to inform the dealer of the dealer's modeled optimized service retention improvement Δro along with the values for the change (e.g., absolute or %) in each controllable factor cᵢ to achieve the optimized service retention improvement Δro. The change in the controllable factor cᵢ is determined, for example, during the perturbation analysis.

At block 124, responsive to an input from the dealer of the cost ($) (e.g., of capital and time in monetary terms) to achieve the change in each controllable factor cᵢ, the processor calculates the optimized service retention improvement Δro per dollar invested $ (referred to hereinafter as optimized service retention improvement efficiency Δro/$) for each controllable factor cᵢ.

At block 126, the processor ranks or orders the controllable factors ci based on the optimized service retention improvement efficiency (Δro/$). The controllable factors ci are ranked in descending order with the controllable factor ci with the highest optimized service retention improvement efficiency (Δro/$) having the highest rank.

At a block 128, the processor displays an object 600 to the dealer to inform the dealer of the dealer's modeled retention improvement for a dollar invested $ in changing a controllable factor cᵢ. Using the object 600, the dealer can determine the most cost effective way to improve the dealer's service retention. Particularly, the object 600 indicates the order in which to spend money on controllable factors in order to maximize the possible improvement in dealer service retention.

The method can be repeated to update the values as new data is measured, which reflects service retention improvements that have been made or that the environment has evolved.

Various embodiments of the present disclosure are disclosed herein. The above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

What is claimed is:

1. A method, comprising:
generating, by a system comprising processor, an improvement model for use in calculating an optimized service retention value wherein the improvement model includes a statistical model based on:
values of uncontrollable factors pertaining to a plurality of dealers;
values of controllable factors pertaining to the plurality of dealers; and
values of actual service retention pertaining to the plurality of dealers;
calculating, by the system, the optimized service retention value for a first dealer of the plurality of dealers, the calculating comprising:
inputting values of uncontrollable factors pertaining to the first dealer into the improvement model; and
inputting values of controllable factors pertaining to the first dealer into the improvement model; and
calculating, by the system, an optimized service retention improvement value in connection with each of a plurality of the controllable factors pertaining to the first dealer, wherein each optimized service retention improvement value represents a change in the optimized service retention value for the first dealer due to a change in an associated one of the plurality of the controllable factors pertaining to the first dealer.

2. The method of claim 1, wherein calculating, by the system, the value of the optimized service retention improvement associated with each of the plurality of the controllable factors pertaining to the first dealer includes performing a sensitivity analysis.

3. The method of claim 1, wherein the statistical model includes a regression model comprising weights, wherein the weights best fit the values of the uncontrollable factors and the values of the controllable factors to the values of actual service retention.

4. The method of claim 1, further comprising generating, by the system, an object for displaying the optimized service retention improvement values associated with each of the plurality of controllable factors, wherein the controllable factors are ordered according to the associated optimized service retention improvement value.

5. The method of claim 4, wherein the object is a Pareto chart.

6. The method of claim 1, further comprising calculating, by the system, responsive to an input of a value of a cost of achieving each of the optimized service retention improvement values, an optimized service retention improvement efficiency value associated with each of the plurality of the controllable factors pertaining to the first dealer, wherein each optimized service retention improvement efficiency value represents a change in the associated optimized service retention improvement value per cost to change the value of an associated one of the controllable factors to achieve the associated optimized served retention improvement value.

7. The method of claim 6, further comprising generating an object displaying the optimized service retention improvement efficiency values associated with each of the plurality of controllable factors, wherein the controllable factors are ordered according to the associated optimized service retention improvement efficiency value.

8. The method of claim 1, further comprising calculating the actual service retention values of the plurality of dealers, comprising, for each of the plurality of dealers, calculating a number of vehicles that have been serviced by the dealer in a category, wherein the category is based on whether a vehicle was sold by the dealer and whether the vehicle is in a geographic area of the dealer.

9. The method of claim 8, wherein the category is one of the group consisting of:
sold by the dealer and within the geographic area of the dealer;
sold by the dealer and outside the geographic area of the dealer;
not sold by the dealer and within the geographic area of the dealer; and
not sold by the dealer and outside the geographic area of the dealer.

10. The method of claim 8, wherein the statistical model is a first statistical model, and the method further comprises:
generating, by the system, a comparison model, wherein the comparison model is a second statistical model based on:
the values of uncontrollable factors pertaining to the plurality of dealers; and
the values of actual service retention of the plurality of dealers; and
calculating, by the system, a benchmarked service retention value for the first dealer of the plurality of dealers, comprising inputting values of uncontrollable factors of the first dealer into the comparison model.

11. The method of claim 10, further comprising generating, by the system, an object displaying a comparison of the actual service retention value of the first dealer to the benchmarked service retention value of the first dealer.

12. A system, comprising:
a processor;
a computer-readable medium comprising computer-executable instructions that, when executed by the processor, cause the processor to perform operations comprising:
generating an improvement model for use in calculating an optimized service retention value wherein the improvement model includes a statistical model based on:
values of uncontrollable factors pertaining to a plurality of dealers;
values of controllable factors pertaining to the plurality of dealers; and
values of actual service retention pertaining to the plurality of dealers;
calculating the optimized service retention value for a first dealer of the plurality of dealers, the calculating comprising:
inputting values of uncontrollable factors pertaining to the first dealer into the improvement model; and
inputting values of controllable factors pertaining to the first dealer into the improvement model; and
calculating an optimized service retention improvement value in connection with each of a plurality of the controllable factors pertaining to the first dealer, wherein each optimized service retention improvement value represents a change in the optimized service retention value for the first dealer due to a change in an associated one of the plurality of the controllable factors pertaining to the first dealer.

13. The system of claim 12, wherein the statistical model includes a regression model comprising weights, wherein the weights best fit the values of the uncontrollable factors and the values of the controllable factors to the values of actual service retention.

14. The system of claim 12, the operations further comprising generating an object for displaying the optimized service retention improvement values associated with each of the plurality of controllable factors, wherein the controllable factors are ordered according to the associated optimized service retention improvement value.

15. The system of claim 12, the operations further comprising:
calculating, responsive to an input of a value of a cost of achieving each of the optimized service retention improvement values, an optimized service retention improvement efficiency value associated with each of the plurality of the controllable factors pertaining to the first dealer, wherein each optimized service retention improvement efficiency value represents a change in the associated optimized service retention improvement value per cost to change the value of an associated one of the controllable factors to achieve the associated optimized served retention improvement value; and
generating an object displaying the optimized service retention improvement efficiency values associated with each of the plurality of controllable factors, wherein the controllable factors are ordered according to the associated optimized service retention improvement efficiency value.

16. The system of claim 12, further comprising calculating the actual service retention values of the plurality of dealers, calculation, for each of the plurality of dealers, calculating a number of vehicles that have been serviced by the dealer in a category, wherein the category is based on whether a vehicle was sold by the dealer and whether the vehicle is in a geographic area of the dealer.

17. The system of claim 16, wherein the category is one of the group consisting of:
sold by the dealer and within the geographic area of the dealer;
sold by the dealer and outside the geographic area of the dealer;
not sold by the dealer and within the geographic area of the dealer; and
not sold by the dealer and outside the geographic area of the dealer.

18. The system of claim 12, wherein the statistical model is a first statistical model and the operations further comprising:
generating a comparison model, wherein the comparison model is a second statistical model based on:
the values of uncontrollable factors pertaining to the plurality of dealers; and
the values of actual service retention of the plurality of dealers; and
calculating a benchmarked service retention value for the first dealer of the plurality of dealers, comprising inputting values of uncontrollable factors of the first dealer into the comparison model.

19. The system of claim 18, the operations further comprising generating an object displaying a comparison of the actual service retention value of the first dealer to the benchmarked service retention value of the first dealer.

20. A computer-readable storage device comprising computer-executable instructions that, when executed by a processor, cause the processor to perform operations comprising:
generating an improvement model for use in calculating an optimized service retention value wherein the improvement model includes a statistical model based on:
values of uncontrollable factors pertaining to a plurality of dealers;
values of controllable factors pertaining to the plurality of dealers; and
values of actual service retention pertaining to the plurality of dealers;
calculating the optimized service retention value for a first dealer of the plurality of dealers, the calculating comprising:
inputting values of uncontrollable factors pertaining to the first dealer into the improvement model; and
inputting values of controllable factors pertaining to the first dealer into the improvement model; and
calculating an optimized service retention improvement value in connection with each of a plurality of the controllable factors pertaining to the first dealer, wherein each optimized service retention improvement value represents a change in the optimized service retention value for the first dealer due to a change in an associated one of the plurality of the controllable factors pertaining to the first dealer.
